(19) United States
(12) Patent Application Publication
(10) Pub. No.: US 2013/0120835 A1
(43) Pub. Date: May 16, 2013

(54) SCREEN AND METHOD FOR MANUFACTURING SCREEN

(71) Applicant: SEIKO EPSON CORPORATION, Tokyo (JP)

(72) Inventors: Kazuo AOKI, Chino-shi (JP); Masashi KITABAYASHI, Azumino-shi (JP)

(73) Assignee: SEIKO EPSON CORPORATION, Tokyo (JP)

(21) Appl. No.: 13/648,030

(22) Filed: Oct. 9, 2012

(30) Foreign Application Priority Data
Nov. 14, 2011 (JP) 2011-248289

(51) Int. Cl. G03B 21/56

(52) U.S. Cl. 359/449; 264/1.9

(57) ABSTRACT

A screen can advance light from a projector to the front efficiently with an appropriate angle distribution, and provides a high-luminance high contrast image inexpensively and easily. The screen includes a concave-convex screen base which reflects projected light and performs display. A metal reflection film is formed by transfer from a transfer foil. A protection film is formed on the surface of the metal reflection film. A method for manufacturing a screen includes heat transfer of the transfer foil to a screen material and base deformation in which concave and convex portions on the screen material are formed.

### BACKGROUND

1. Technical Field

The present invention relates to a screen and a method for manufacturing a screen.

2. Related Art

Traditionally, a screen which reflects projected light projected from a projection-type display device such as a projector and thus displays an image is known. JP-A-2010-96883 discloses a screen in which plural concave surface portions having a concave shape and arranged on a flat surface are provided and arranged in such a way that as concave surface portion is away from a reference point on the flat surface or a surface extending from the flat surface, the pitch of the concave surface portion in a radiating direction about the reference point is increased. Thus, light from the projector is made to advance to the front efficiently with an appropriate angle distribution, and an image with high luminance and high contrast is provided.

In the screen disclosed in JP-A-2010-96883, a reflection layer made of a metal thin film is formed at a specific position on each concave portion formed on the screen, in order to reflect projected light from the projector efficiently to the front direction. The projector is placed, for example, at a low position in relation to the screen. Projected light from that position is reflected to the front by the screen. JP-A-2010-96883 discloses the formation of a reflection layer at a position above a vicinity of the center of the concave surface portions of the screen, in order to make the projected light advance efficiently to the front and to reduce reflection of external light.

Here, in order to reflect the projected light from the projector efficiently to the side of a viewer of video and to provide a video with high contrast, the concave portions and the reflection layer formed at a specific position on the concave portions need to be formed accurately in relation to the center axis in left-right direction of the screen and the optical axis of the projected light projected from the projector.

An inexpensive screen with such high optical capabilities and a screen manufacturing method which can manufacture such a screen easily are desired.

### SUMMARY

An advantage of some aspects of the invention is to solve at least a part of the problems described above, and the invention can be implemented as the following forms or application examples.

### Application Example 1

This application example is directed to a screen which reflects projected light and performs display in a display area and includes a screen base. The screen base has a concave surface shape or a convex surface shape formed on one side of a screen material. A metal reflection film that is formed by transfer from a metal reflection layer formed on a transfer foil is provided on one side of the screen base corresponding to the concave surface shape or the convex surface shape within the display area.

Such a screen can reflect projected light from a projector or the like on the metal reflection film and can make the projected light advance efficiently toward a viewer of video.

Also, since the metal reflection film formed within the display area of the screen base is formed by transfer from the metal reflection layer formed on the transfer foil, the metal reflection film can be easily and continuously formed without using an oblique deposition method with a traditional evaporation device, and the screen can be provided less expensively.

### Application Example 2

This application example is directed to the screen according to the above application example, wherein a reflection reducing film is formed at a site where the metal reflection film is not formed by transfer, corresponding to the concave surface shape or the convex surface shape.

According to such a screen, a screen with higher contrast which can reduce reflection of external light from the surroundings that is not projected light from a projector can be provided inexpensively.

### Application Example 3

This application example is directed to the screen according to the above application example, wherein a reflection reducing film is formed in a portion on the metal reflection film, corresponding to the concave surface shape or the convex surface shape.

According to such a screen, a screen with higher contrast which can reduce reflection of external light from the surroundings that is not projected light from a projector can be provided inexpensively.

### Application Example 4

This application example is directed to the screen according to the above application example, wherein the metal reflection film is formed by transfer substantially at a center of the convex surface shape within the display area.

According to such a screen, a screen which has higher brightness and higher contrast even in an environment where a projector is installed substantially at the same height as the eyes of the viewer of video or behind the viewer of video, can be provided inexpensively.

### Application Example 5

This application example is directed to the screen according to the above application example, wherein the screen base is made of a non-light-transmissive base.

According to such a screen, a screen with higher contrast which can absorb external light from the surroundings that is not projected light from a projector can be provided inexpensively.

### Application Example 6

This application example is directed to the screen according to the above Application Example 1, wherein the screen base is a light-transmissive base and the metal reflection film is formed by transfer at a position on a back side corresponding to a center of the concave surface shape or the convex surface shape within the display area.

According to such a screen, in an environment where a projector is substantially at the same height as the eyes of the viewer of video and no lighting is arranged behind the viewer of video, external light from lighting or the like situated above the viewer of video or the screen is transmitted through the screen base and unwanted external reflected light can be reduced. Therefore, a less expensive screen which efficiently reflects projected light emitted from a projector and has a capability of bright display can be provided easily. Moreover, the reflection reducing film is not needed.

### Application Example 7

This application example is directed to the screen according to the above application example, wherein a protection film which protects the metal reflection film is formed by transfer simultaneously with the metal reflection film.

According to such a screen, deterioration in reflectance due to moisture in the air or the like can be prevented. Also, a screen in which the protection film can be easily manufactured and which has strain resistance, long life and high commercial value can be provided inexpensively.

### Application Example 8

This application example is directed to the screen according to the above application example, wherein the metal reflection film is an aluminum thin film.

According to such a screen, an inexpensive screen which has a reflectance of about 80% or higher in a visible spectrum range for projected light from a projector or the like, and which has a display characteristic similar to natural color, no tinting and high surface luminance, can be provided.

### Application Example 9

This application example is directed to the screen according to the above application example, wherein the screen base is made of a hard vinyl chloride resin.

According to such a screen, a screen base which can be molded at a relatively low heat molding temperature of approximately 150 to 190° C. and which has excellent moldability and low surface roughness on the surface where the metal reflection film is formed, can be provided. Also, a long-life screen with excellent contactability of the metal reflection film can be provided. Moreover, curling of the screen does not occur. That is, a screen that can be accommodated in a smaller housing by having a roll-up mechanism can be provided.

### Application Example 10

This application example is directed to the screen according to the above application example, wherein the reflection reducing film is made of a solid form of black resin paint.

According to such a screen, reflected light intensity of external light from lighting or the like situated above the viewer of video is further reduced and unwanted external reflected light can be prevented from entering the eyes of the viewer of video. Therefore, a screen which efficiently reflects projected light emitted from a projector to the viewer of video and has a capability of bright display can be provided easily.

### Application Example 11

This application example is directed to a method for manufacturing a screen which reflects projected light and performs display. The method includes: reflection film transfer in which at least a metal reflection film is formed by transfer using a transfer foil on one side of a screen material; and base deformation in which a concave surface shape or a convex surface shape is molded with a flat mold on one side of the screen material, thus forming a screen base.

In such a screen, a reflection film with a high reflectance equivalent to an evaporated film can be manufactured inexpensively, without using a metal material deposition method, which is an example of a method for forming a metal reflection film. Also, since the metal reflection layer is formed in advance on a large-area transfer foil, the manufacturing cost of the screen can be reduced significantly.

### Application Example 12

This application example is directed to the screen manufacturing method according to the above application example, wherein the reflection film transfer and the base deformation are carried out simultaneously.

According to such a screen manufacturing method, the base deformation of the screen base and the reflection film formation can be carried out simultaneously. Consequently, the processing cost in manufacturing the screen can be reduced significantly and the screen can be manufactured less expensively.

### Application Example 13

This application example is directed to the screen manufacturing method according to the above application example, which further includes reflection reducing film formation in which a reflection reducing film is formed on one side of the screen base.

With such a screen manufacturing method, since the reflection reducing film is formed, a screen with higher contrast can be manufactured.

### Application Example 14

This application example is directed to the screen manufacturing method according to the above application example, wherein the reflection film transfer, the base deformation and the reflection reducing film formation are carried out simultaneously.

With such a screen manufacturing method, the screen can be manufactured less expensively.

### Application Example 15

This application example is directed to the screen manufacturing method according to the above application example, which further includes alignment in which the flat mold and the transfer foil are aligned in position so that position marks formed at positions corresponding to at least two or more corners on a surface of the flat mold used in the base deformation and position marks formed at positions corresponding to at least two or more corners on the transfer foil as a base for transferring the metal reflection film meet each other.

With such a screen manufacturing method, the metal reflection film can be formed freely and accurately at a desired position on each concave surface shape or convex surface shape on the metal reflection layer of the transfer foil or on the screen.

More specifically, the metal reflection layer of the transfer foil or a hot melt adhesive layer is processed in fine patterns in advance, using a technique such as printing or photolithography. The processing cost of the large-area transfer foil, thus manufactured, is inexpensive. By aligning the flat mold and the transfer foil so that the position marks on the transfer foil meet the position marks on the flat mold and then carrying out heat pressing, which is an example of the base deformation of the screen base, the metal reflection film can be formed at a desired position on the screen base. Consequently, the processing cost in manufacturing the screen can be reduced significantly.

### Application Example 16

This application example is directed to the screen manufacturing method according to the above application example, wherein the base deformation and the reflection film transfer includes heat pressing.

With such a screen manufacturing method, the base deformation of the screen base and the reflection film formation can be carried out simultaneously. Consequently, the processing cost in manufacturing the screen can be reduced significantly.

### Application Example 17

This application example is directed to the screen manufacturing method according to the above application example, which further includes spraying of a reflection reducing agent.

With such a screen manufacturing method, there is no risk of damage to the concave surface shape or the convex surface shape formed on one side of the screen, and appearance yield can be improved by preventing scratches or the like. Also, since the concave surface shape or the convex surface shape is not damaged, projected light from a projector or the like can be reflected efficiently.

### BRIEF DESCRIPTION OF THE DRAWINGS

The invention will be described with reference to the accompanying drawings, wherein like numbers reference like elements.

FIG. 1 is a schematic sectional view of a screen according to an embodiment.

FIG. 2 is a schematic sectional view of a screen according to an embodiment.

FIG. 3 is a schematic sectional view of a screen according to an embodiment.

FIG. 4 is a schematic sectional view of a screen according to an embodiment.

FIG. 5 is a schematic sectional view of a screen according to an embodiment.

FIG. 6 is a schematic sectional view of a screen according to an embodiment.

FIG. 7 is a schematic sectional view showing a reflection film transfer process according to an embodiment.

FIG. 8 is a schematic sectional view showing a base deforming process according to an embodiment.

FIG. 9 is a schematic sectional view showing a reflection reducing film forming process according to an embodiment.

FIG. 10 is a schematic sectional view showing reflection film formation and base deforming processes according to an embodiment.

FIG. 11 is a schematic sectional view showing a reflection reducing film forming process according to an embodiment.

FIG. 12 is a schematic view showing reflection film forming and base deforming processes according to an embodiment.

FIG. 13 shows a path of light on the screen according to an embodiment.

FIG. 14 shows a path of light on the screen according to an embodiment.

FIG. 15 is a top view showing an example of alignment marks and discrimination marks according to an embodiment.

FIG. 16 is a perspective view showing positions where alignment marks and discrimination marks are arranged.

FIG. 17 shows an arrangement position of concave surface shapes or convex surface shapes on the screens according to an embodiment.

FIG. 18 shows an arrangement position of concave surface shapes or convex surface shapes on the screens according to an embodiment.

FIG. 19 is a schematic view showing a process in which a reflection film transfer process and a base deforming process are carried out simultaneously.

FIG. 20 is a conceptual view showing a transfer foil with a reflection reducing layer where the reflection reducing layer is formed by printing.

FIG. 21 is a schematic view showing a process in which a metal reflection layer, a protection layer of the metal reflection layer, and a reflection reducing layer are transferred simultaneously.

### DESCRIPTION OF EXEMPLARY EMBODIMENTS

Hereinafter, an embodiment will be described with reference to the drawings.

In the description of this embodiment, it is assumed that the top side of the drawings is the upper side (upper part) in vertical direction and that the bottom side is the lower side (lower part) in vertical direction.

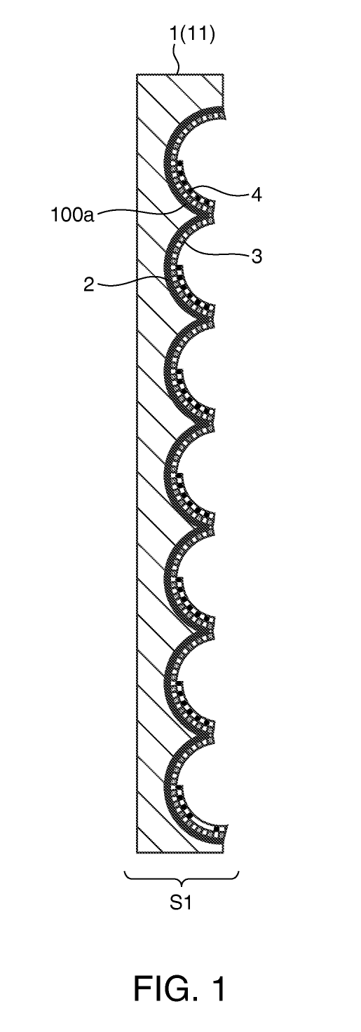

FIGS. 1 to 6 show, as an example of state of use, a state where a screen is provided upright so that a screen projection surface extends in vertical direction and where a viewer of video (viewer) and a projector are arranged to the right in the drawing, which is the direction of the projection surface.

### Embodiment 1

### Structure of Screen

FIG. 1 schematically shows a cross section of a screen S1 according to this embodiment.

As shown in FIG. 1, the screen S1 includes a concave-convex screen base 1 as a screen base. In the concave-convex screen base 1, plural concave surface shapes 100a are formed on one side of a screen material 11 made of a non-light-transmissive material.

A metal reflection film 2 is formed on the entire surface of each concave surface shape 100a. Moreover, a protection film 3 is formed on the surface of the metal reflection film 2. Also, a reflection reducing film 4 is formed at a part of each concave surface shape 100a formed in the concave-convex screen base 1.

The screen material 11 is made of hard vinyl chloride. In addition, thermoplastic resins such as polyethylene, polypropylene, styrene resin, butadiene resin, methacrylate resin, vinyl chloride, polyamide, polyacetal, polyethylene terephthalate, polybutylene terephthalate, methyl pentene, butyl pentene and polycarbonate may be used.

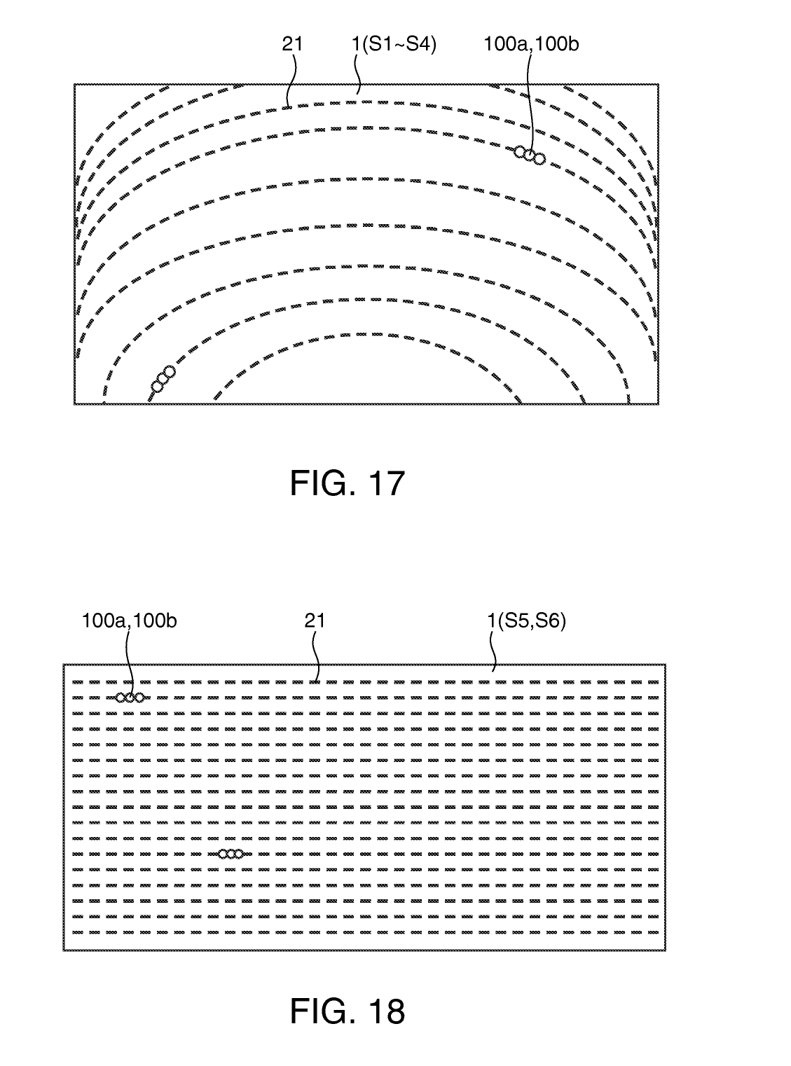

The concave surface shapes 100a are formed along arcuate arrangement positions 21 around a point that is set in a lower part in relation to the screen S1, as shown in FIG. 17. The radius of curvature of the concave surface shape 100a is, for example, approximately 100 μm. In FIG. 17, the arrangement positions 21 of the concave surface shapes 100a are conceptually shown by lines at spacing. The actual arcs of the arrangement positions 21 are close to each other. The minimum value of the distance in diagonal direction of a ridgeline formed by the neighboring concave surface shapes 100a is, for example, approximately 100 μm.

The metal reflection film 2 is formed in order to reflect mainly light from a projector, of light that becomes incident on the screen S1. The metal reflection film 2 is made of an aluminum evaporated film that is about 0.1-μm thick. Also, an evaporated film of sliver or the like, or a multilayer optical film may be used.

The protection film 3 is formed in order to protect the surface of the metal reflection film 2. The protection film 3 is made of a mixture of 60 parts by weight of a 2-μm thick polymethyl methacrylate resin and 40 parts by weight of Teflon (trademark registered) powder. Also, other thermoplastic resins, for example, epoxy resin or the like, can be used. Meanwhile, as other antifriction agents, polyethylene powder, natural wax, synthetic wax and the like can be used. Also, thin films of silicon oxide, aluminum oxide and the like may be used.

The reflection reducing film 4 is formed in order to reduce reflection particularly of light (so-called external light) that is not light from a projector, of light that becomes incident on the screen S1, toward the viewer of video. In this embodiment, the reflection reducing film 4 has a characteristic of absorbing incident light and consequently reduces reflection. The reflection reducing film 4 is made of a mixture of a 2-μm thick acrylic resin binder and carbon particles. Other resins, for example, polyamide resin or polyethylene terephthalate, may be used as a binder. In addition to carbon particles, black pigment particles may be used.

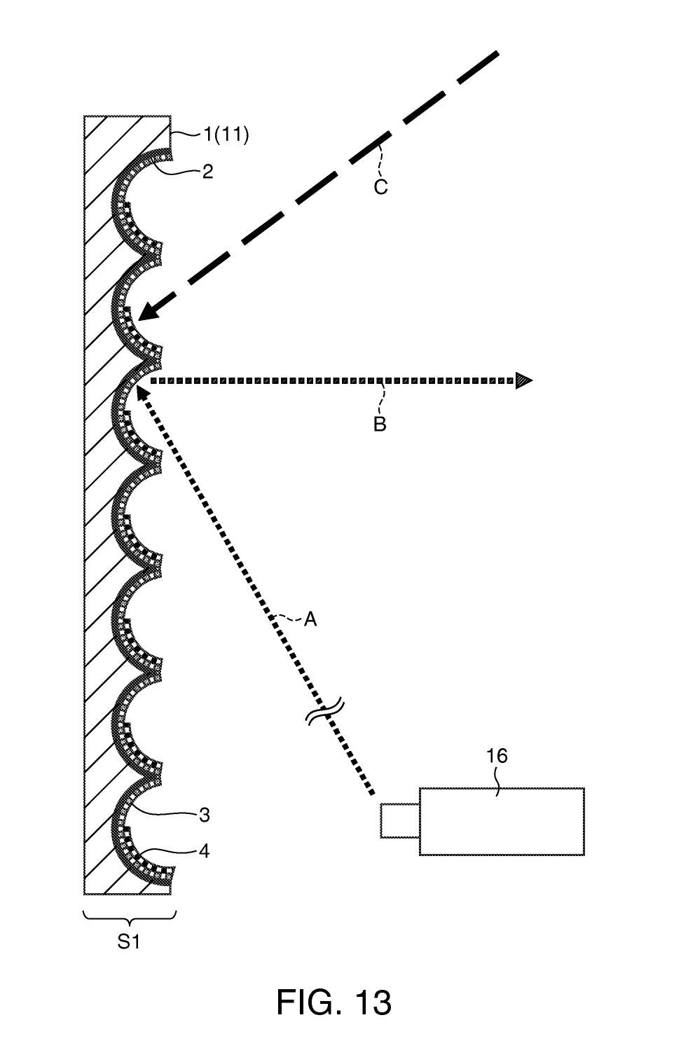

FIG. 13 shows a conceptual view of a path of light in the case where projected light from a projector 16 and external light become incident on the screen S1. In FIG. 13, light traveling through a path A, of the projected light from the projector 16 placed at a low position in relation to the screen S1, is reflected by the metal reflection film 2 within the concave surface shape 100a, then travels through a path B and advances toward the viewer. Meanwhile, external light from a lighting device or the like installed on the ceiling of the room is cast from a high position in relation to the screen S. Therefore, on the surface of the concave surface shape 100a of the screen S1, the external light becomes incident on a lower surface that faces the lighting device. The external light which becomes incident on the concave-convex screen base 1 along a path C is absorbed by the reflection reducing film 4 formed at the position of the incidence. Therefore, the external light is significantly reduced in intensity of reflected light and does not advance toward the viewer.

### Method for Manufacturing Screen

A method for manufacturing the screen S1 shown in FIG. 1 will be described.

In this embodiment, the screen S1 is manufactured through a reflection film transfer process, a base deforming process and a reflection reducing film forming process.

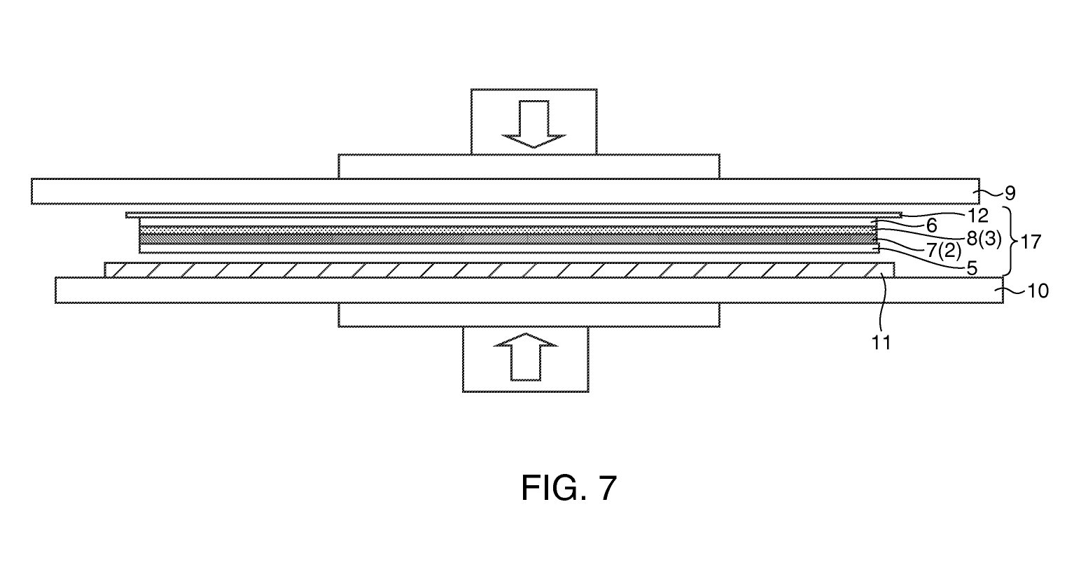

FIG. 7 shows a schematic view of a reflection film transfer process.

In the reflection film transfer process, the screen material 11 and a transfer foil 17 are superimposed and held between a top pressing plate 9 situated at the top and a bottom pressing plate 10 situated at the bottom and then thermocompression is carried out to perform transfer.

As shown in FIG. 7, the screen material 11 is set on a substantially flat top surface of the bottom pressing plate 10 that is heated in advance, and the transfer foil 17 is set on a top surface of the screen material 11.

The transfer foil 17 is a multilayer body including an approximately 20-μ thick transfer foil base 12, an adhesive layer 6, a protection layer 8 of a metal reflection layer 7, the metal reflection layer 7, and a hot melt adhesive layer 5 stacked in order. Each of these layers is a sub-μ or several-μ thick and is stacked on one side (surface) of the transfer foil base 12 by continuous evaporation of a metal or by coating or print coating of a resin material or the like.

When the transfer foil 17 is set on the top surface of the screen material 11, the transfer foil 17 is situated in such a way that the top surface of the screen material 11 and the hot melt adhesive layer 5 face each other while the other side of the transfer foil base 12 where nothing is stacked faces the substantially flat surface of the top pressing plate 9.

Thermocompression of each member, thus set, is carried out using the heated top pressing plate 9 and bottom pressing plate 10. The hot melt adhesive layer 5 is melted by heat and the metal reflection layer 7 and the protection layer 8 are transferred to the screen material 11. This process is equivalent to heat pressing.

Since the adhesive layer 6 left on the surface of the transfer foil base 12 loses the adhesive function, the transfer foil base 12 is stripped off the protection film 3 transferred to the screen material 11. Thus, a screen material 18 with the metal reflection film 2 and the protection film 3 transferred thereto is formed.

In this embodiment, thermocompression is carried out at 150 to 160° C.

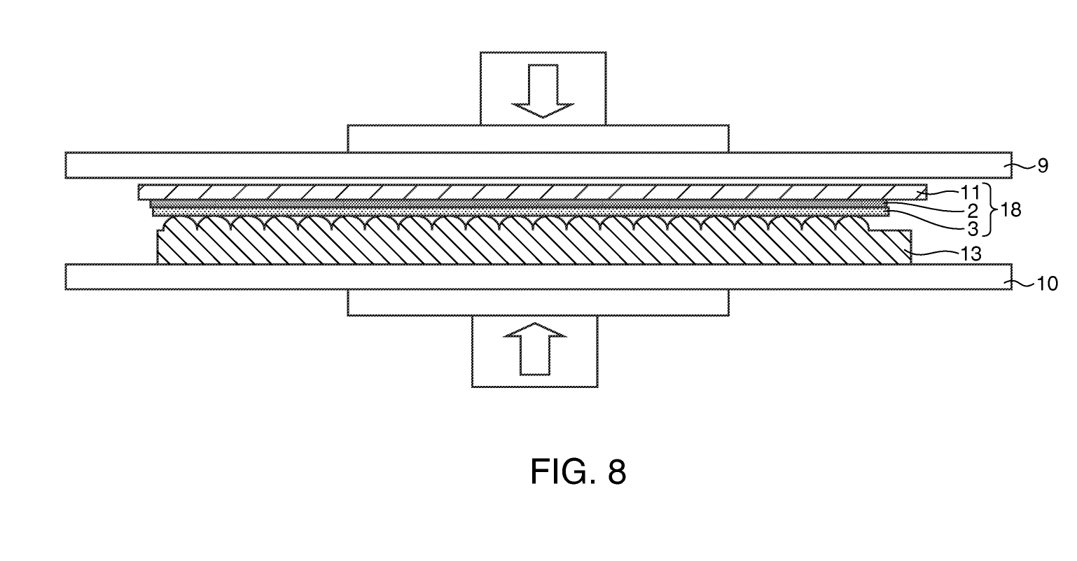

FIG. 8 shows a schematic view of a base deforming process.

In the base deforming process, a convex-flat mold 13 which is substantially flat on one side and has convex and concave shapes on the other side that is opposite to the one side, and the screen material 18 are superimposed and held between the top pressing plate 9 situated at the top and the bottom pressing plate 10 situated at the bottom, and then these members are pressed while being heated. Thus, concave surface shapes are formed on one side of the screen material 18.

As shown in FIG. 8, the convex-flat mold 13 is set on the substantially flat top surface of the bottom pressing plate 10 in such a way that the one side of the convex-flat mold 13 faces the bottom pressing plate 10.

Next, the screen material 18 is set on the top surface of the convex-flat mold 13 which is heated in advance in such a way that the screen material 11 faces the substantially flat surface of the top pressing plate 9 and that the protection film 3 faces the convex-flat mold 13. After that, heat pressing is carried out using the heated top pressing plate 9 and bottom pressing plate 10. This process is equivalent to heat processing.

By this base deforming process, the shaping of the screen material 11 and the deformation of the protection film 3 and the metal reflection film 2 proceed. Thus, a screen intermediate body 20 with concave surface shapes formed on one side is obtained.

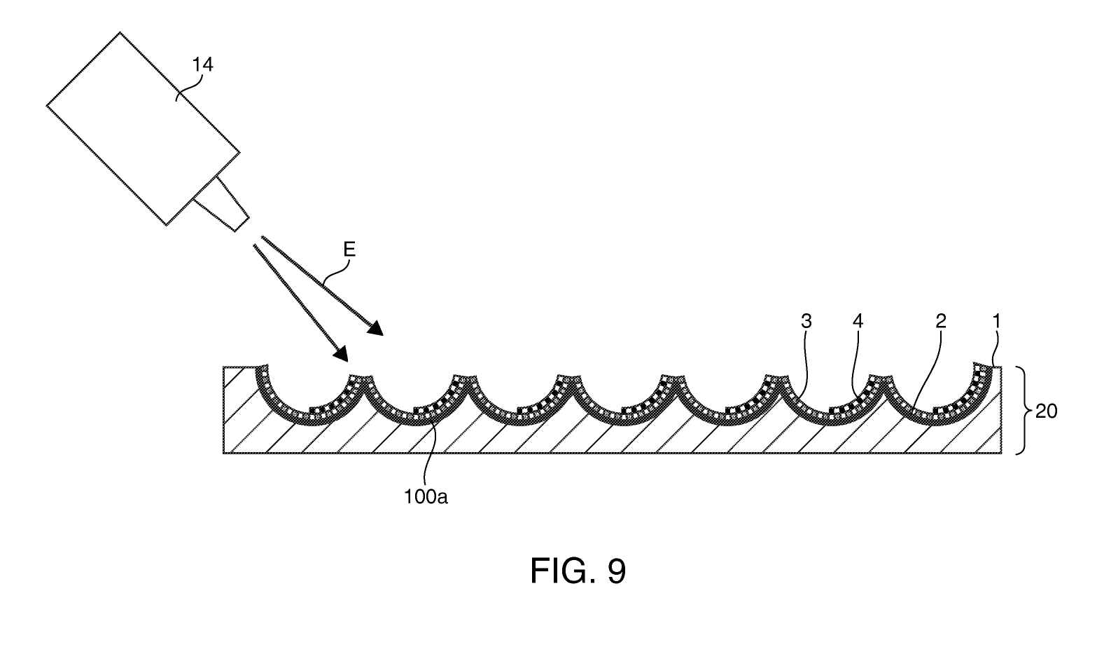

FIG. 9 shows a schematic view of a reflection reducing film forming process.

In the reflection reducing film forming process, a reflection reducing agent is sprayed to the screen intermediate body 20 as a screen base, thus forming a reflection reducing film.

As shown in FIG. 9, the screen intermediate body 20 is placed, for example, in such a way that the concave-convex screen base 1 is on the bottom side while the protection film 3 and the metal reflection film 2 are on the top side and that the longitudinal direction of the screen intermediate body 20 follows horizontal direction. In FIG. 9, the screen intermediate body 20 is placed in such a way that the site located at the top in vertical direction when the screen S1 is in the state of use shown in FIG. 1 is the left side in FIG. 9 while the site located at the bottom is the right side in FIG. 9.

The reflection reducing agent accommodated in a spray device 14 is ejected from the left in FIG. 9, passes through a path E and is sprayed and applied onto the screen intermediate body 20. After that, the reflection reducing agent is solidified to form the reflection reducing film 4.

The reflection reducing agent passes through the path E, inclined in relation to the surface where the concave surface shapes 100a are formed, of the screen intermediate body 20, and is sprayed obliquely from the top left side in FIG. 9. The reflection reducing agent, sprayed through the path E, is obstructed by a convex portion at an end of the concave surface shape 100a and therefore is not applied to substantially left half portion of the concave surface shape 100a. In other words, the convex portion at the end of the concave surface shape 100a blocks the applied reflection reducing agent, and the reflection reducing agent is applied only to a substantially right half portion of the concave surface shape 100a, which is shown as the lower part thereof in FIG. 1. In this manner, the screen S1 shown in FIG. 1 is provided.

### Embodiment 2

Next, a screen according to Embodiment 2 and a manufacturing method for the screen will be described. The same description as in the above embodiment will be omitted.

### Structure of Screen

The structure of the screen according to this embodiment is similar to Embodiment 1.

### Method for Manufacturing Screen

In the above Embodiment 1, the screen S1 is manufactured through a reflection film transfer process, a base deforming process, and a reflection reducing film forming process. In this embodiment, a reflection film transfer process and a base deforming process are carried out simultaneously.

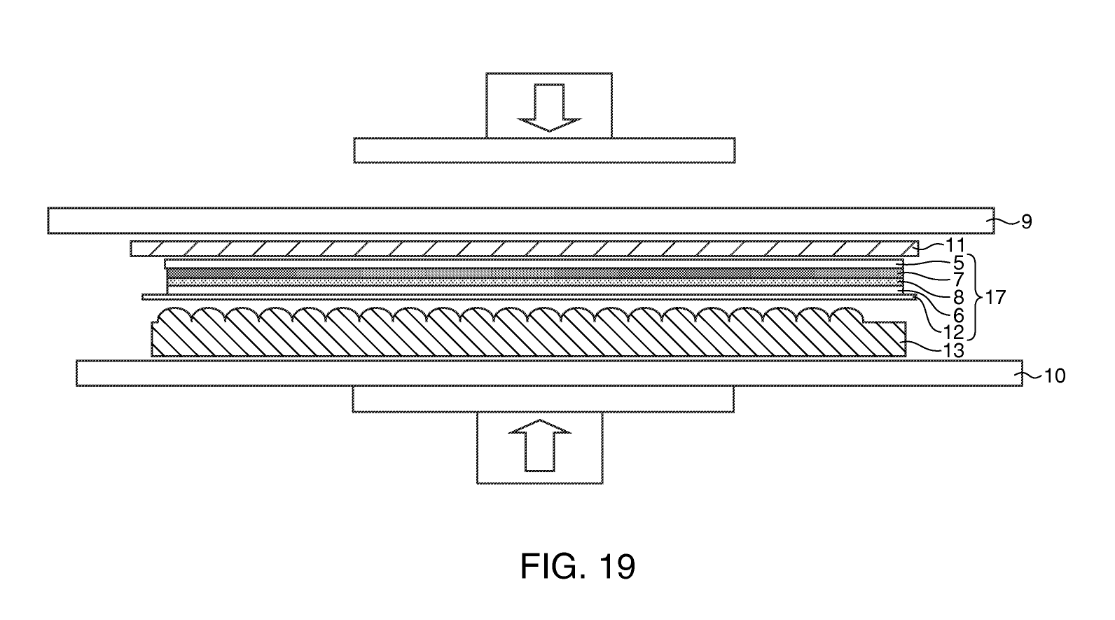

FIG. 19 shows a schematic view of a process in which a reflection film transfer process and a base deforming process are carried out simultaneously.

As shown in FIG. 19, the convex-flat mold 13 is set on the bottom pressing plate 10 that is heated in advance, in such a way that one side of the convex-flat mold 13 that is substantially flat faces the bottom pressing plate 10.

Moreover, the transfer foil 17 is set in such a way that the other side of the transfer foil base 12 where nothing is stacked faces the top side of the convex-flat mold 13. The screen material 11 is set on the top side of the transfer foil 17 in such a way as to face the hot melt adhesive layer 5.

The transfer foil 17 is the same multilayer body as in Embodiment 1. In this Embodiment 2, the setting direction in the reflection film transfer process (see FIG. 7) in Embodiment 1 is vertically reversed. Thermocompression of each member, thus set, is carried out using the heated top pressing plate 9 and bottom pressing plate 10. Thus, the hot melt adhesive layer 5 is melted by heat and the metal reflection layer 7 and the protection layer 8 are transferred to the screen material 11. The deformation of the screen material 11 proceeds with the convex-flat mold 13 simultaneously with the transfer.

That is, the shaping of the screen material 11 and the deformation of the protection layer 8 (protection film 3) and the metal reflection layer 7 (metal reflection film 2) proceed simultaneously. After thermocompression, the transfer foil base 12 is stripped off the protection film 3 transferred to the screen material 11. Thus, the screen intermediate body 20 is obtained.

After that, the reflection reducing film 4 is formed similarly to Embodiment 1 and the screen S1 is thus obtained.

### Embodiment 3

Next, a screen according to Embodiment 3 and a manufacturing method for the screen will be described. The same description as in the above embodiments will be omitted.

### Structure of Screen

The structure of the screen according to this embodiment is similar to Embodiment 1.

### Method for Manufacturing Screen

In this embodiment, a reflection film transfer process and a base deforming process are carried out simultaneously using a transfer foil with reflection reducing layer 22 on which a reflection reducing layer 23 is additionally printed, instead of the transfer foil 17 used in Embodiment 1. Thus, the above reflection reducing layer forming process is carried out simultaneously with the reflection film transfer process and the base deforming process.

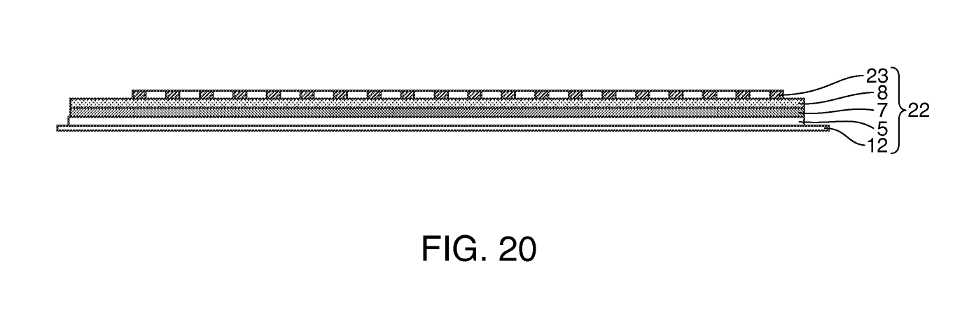

FIG. 20 is a conceptual view of the transfer foil with reflection reducing layer 22 on which the reflection reducing layer 23 is formed by printing. The transfer foil with reflection reducing layer 22 is a multilayer body in which the hot melt adhesive layer 5, the metal reflection layer 7 and the protection layer 8 of the metal reflection layer 7 are formed on the approximately 20-μ thick transfer foil base 12 as in Embodiment 1 and in which the reflection reducing layer 23 is additionally formed by printing.

Moreover, an alignment mark is printed on the transfer foil with reflection reducing layer 22. Alignment is carried out using this alignment mark and a discrimination mark. The alignment mark and the alignment will be described in detail later.

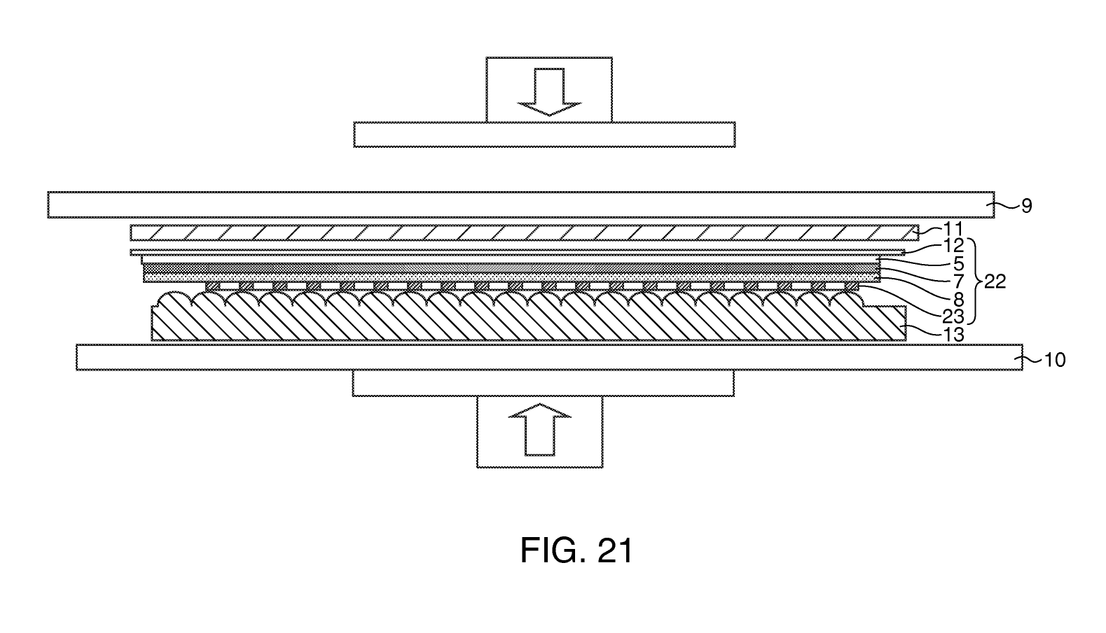

As shown in FIG. 21, in this embodiment, heat pressing is carried out as in Embodiment 2 (see FIG. 19) using the transfer foil with reflection reducing layer 22. By such a method, the transfer of the metal reflection layer 7, the protection layer 8 of the metal reflection layer 7 and the reflection reducing layer 23 is carried out simultaneously with the shaping of the screen material 11. Moreover, the deformation of the protection layer 8 (protection film 3), the metal reflection layer 7 (metal reflection film 2) and the reflection reducing layer 23 is carried out simultaneously.

### Embodiment 4

Next, a screen according to Embodiment 4 and a manufacturing method for the screen will be described. The same description as in the above embodiments will be omitted.

### Structure of Screen

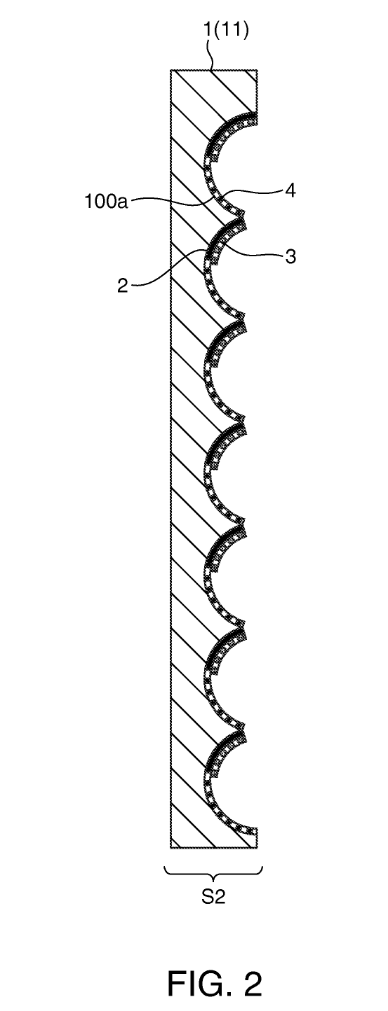

FIG. 2 schematically shows a cross section of a screen S2 according to this embodiment.

As shown in FIG. 2, in the concave-convex screen base 1 of the screen S2, plural concave surface shapes 100a are formed on one side of the screen material 11, as in the screen S1.

On the surface of each concave surface shape 100a, the metal reflection film 2 is formed in an upper part of the concave surface shape 100a. This is for the purpose of reflecting incident light toward the viewer of video because projected light from the projector 16 placed at a low position in relation to the screen S2 becomes incident an upper surface that faces the projector 16, of the surface of the concave surface shape 100a. Moreover, the protection film 3 is formed on the surface of the metal reflection film 2.

Also, the reflection reducing film 4 is formed at the site where the metal reflection film 2 is not formed by transfer, on the surface of each concave surface shape 100a. In this embodiment, the reflection reducing film 4 may have a light absorbing function or may simply have a reflection preventing function alone. The reflection reducing film 4 having a reflection preventing function is made of, for example, a high molecular compound such as polytetrafluoro methylmethacrylate.

The projected light from the projector, incident on the screen S2 according to this embodiment, is reflected toward the viewer of video, as in the case of the screen S1 according to the above embodiments. Meanwhile, if the reflection reducing film 4 has a light absorbing function, external light is absorbed by the reflection reducing film 4. If the reflection reducing film 4 has only a reflection preventing function, external light is transmitted through the reflection reducing film 4 and is absorbed by the screen material 11 made of a non-light-transmissive material.

### Method for Manufacturing Screen

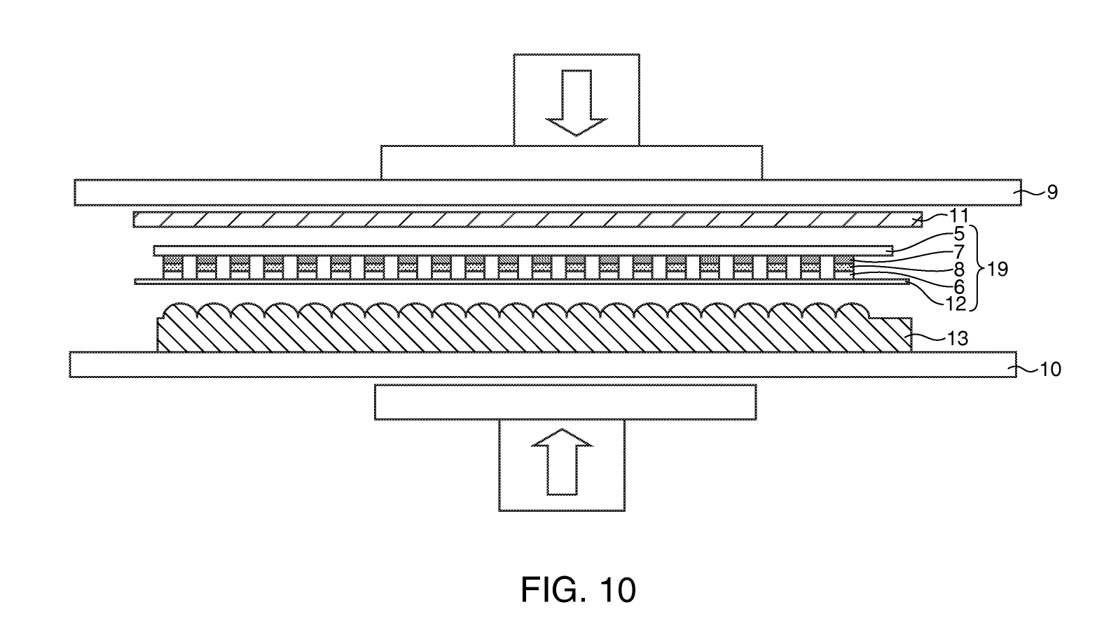

FIG. 10 shows a schematic view of a reflection film forming process and a base deforming process.

In this embodiment, a reflection film transfer process and a base deforming process are carried out simultaneously using a transfer foil 19 on which the metal reflection layer 7, the protection layer 8 and the adhesive layer 6 are interspersed, instead of the transfer foil 17 used in Embodiment 2. Thus, the above reflection reducing layer forming process is carried out simultaneously with the reflection film transfer process and the base deforming process.

As shown in FIG. 10, the convex-flat mold 13 is set on the substantially flat surface of the bottom pressing plate 10 which is heated in advance, in such a way that the one side of the convex-flat mold 13 that is substantially flat faces the bottom pressing plate 10. Moreover, the transfer foil 19 is set in such a way that the other side of the transfer foil base 12 where nothing is stacked faces the top side of the convex-flat mold 13.

The transfer foil 19 is a multilayer body including the approximately 20μ thick transfer foil base 12, the adhesive layer 6, the protection layer 8 of the metal reflection layer 7, the metal reflection layer 7, and the hot melt adhesive layer 5. The metal reflection layer 7, the protection layer 8 and the adhesive layer 6 are patterned and interspersed in advance in such a way as to meet the arrangement positions of the concave surface shapes 100a formed on the surface of the screen material 11 and a desired transfer position of the metal reflection film 2 within each concave surface shape 100a. Each layer is finely processed to a thickness of sub-μ to several μ as described above, by a technique such as continuous evaporation of a metal aluminum, or coating, print coating or photolithography of a resin material.

The screen material 11 is arranged in such a way as to face the top side of the transfer foil 19.

Each member, thus set, is heat-pressed using the heated top pressing plate 9 and bottom pressing plate 10.

The hot melt adhesive layer 5 is melted by heat and the metal reflection layer 7 and the protection layer 8 are transferred and shaped (deformed) at a desired position on the screen material 11. After heat pressing, the transfer foil base 12 is stripped off the protection film 3 of the metal reflection film 2 transferred to the concave-convex screen base 1. Thus, the screen intermediate body 20 of the screen S2 is formed.

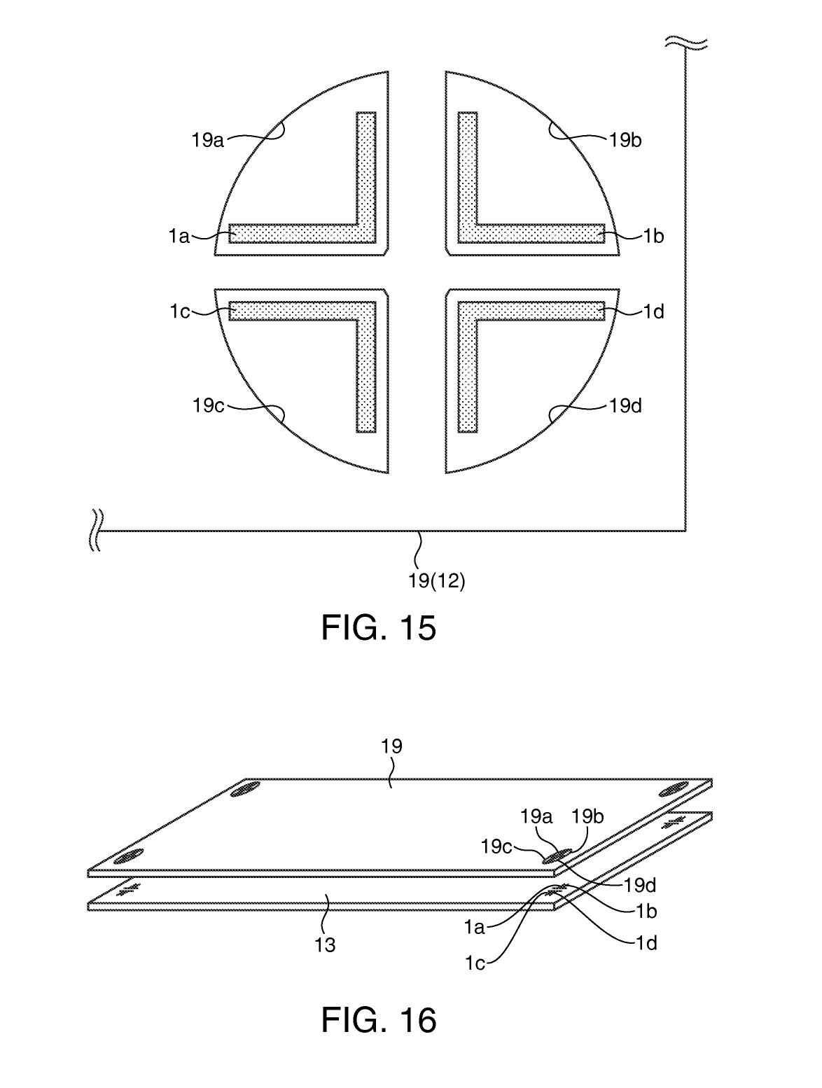

Here, the position where the concave surface shapes 100a on the convex-flat mold 13 and the position of the metal reflection layer 7 interspersed in the transfer foil 19 need to be aligned with each other precisely. An alignment process for these positions will now be described with reference to FIGS. 15 and 16.

FIG. 15 is a top view showing an example of alignment marks and discrimination marks appearing in corners when the convex-flat mold 13 and the transfer foil 19 are superimposed. FIG. 16 is a schematic perspective view showing the positions where alignment marks and discrimination marks are provided when the transfer foil 19 is placed on the top side of the convex-flat mold 13.

As shown in FIG. 16, when the transfer foil 19 is superimposed and placed on the top side of the convex-flat mold 13, four sectorial holes 19a, 19b, 19c, 19d, each being a quarter of a circle, as shown in FIG. 15 are formed in each of the four corners of the transfer foil 19.

These four sectorial holes 19a, 19b, 19c, 19d are provided in contact with the transfer foil base 12 in the shape of a cross as viewed in a plane view, passing through the center of the circle and having a uniform width. Hereinafter, this shape is referred to as an alignment mark.

The arrangement distribution of the metal reflection layer 7 and the like interspersed in the transfer foil 19 is formed, based on the alignment marks.

Meanwhile, L-shaped discrimination marks 1a, 1b, 1c, 1d shown in FIG. 15 are formed in each of the four corners of the convex-flat mold 13. The arrangement position of the convex shapes formed on the convex-flat mold 13 is determined based on the discrimination marks 1a, 1b, 1c, 1d.

That is, by aligning the convex-flat mold 13 with the transfer foil 19 in such a way that the holes of the alignment marks 19a, 19b, 19c, 19d and the discrimination marks 1a, 1b, 1c, 1d are superimposed on each other, the metal reflection film 2 and the protection film 3 can be formed at desired positions on the concave-convex screen base 1.

The alignment marks (holes 19a, 19b, 19c, 19d) and the discrimination marks 1a, 1b, 1c, 1d in this embodiment are equivalent to position marks.

The reflection reducing film 4 formed on the screen S2 can be similarly formed by the method described as the method for manufacturing the screen S1. Therefore, the description of the reflection reducing film forming process is omitted.

### Embodiment 5

Next, a screen according to Embodiment 5 and a manufacturing method for the screen will be described. The same description as in the above embodiments will be omitted.

### Structure of Screen

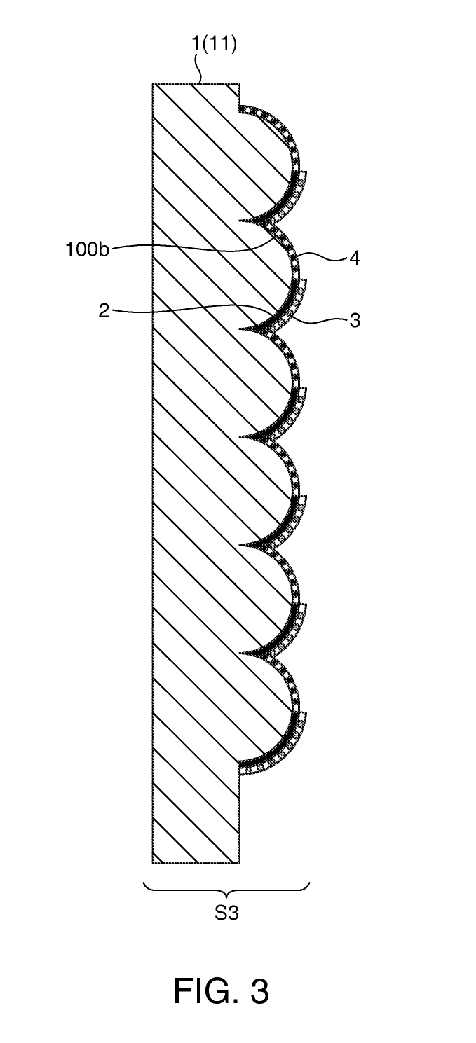

FIG. 3 schematically shows a cross section of a screen S3.

As shown in FIG. 3, in the concave-convex screen base 1 of the screen S3, plural convex surface shapes 100b are formed on one side of the screen material 11. The planar arrangement of the formed convex surface shapes 100b is similar to the concave surface shapes 100a of the screen S1.

On the surface of each convex surface shape 100b, the metal reflection film 2 is formed in a lower part that faces a projector placed in a low position in relation to the screen. Moreover, the protection film 3 is formed on the surface of the metal reflection film 2. Also, on the surface of each convex surface shape 100b, the reflection reducing film 4 is formed at the site where the metal reflection film 2 is not formed by transfer.

When projected light from the projector and external light become incident on the screen S3, the projected light from the projector arranged in a low position in relation to the screen S3 is reflected by the metal reflection film 2 of the convex surface shape 100b and advances toward the viewer. Meanwhile, the external light that becomes incident on the reflection reducing film 4 is significantly reduced in intensity of reflected light and therefore does not advance toward the viewer. This is similar to the cases of the screen S1 and S2 according to embodiments and therefore will not be described further in detail.

### Method for Manufacturing Screen

A method for manufacturing the screen S3 is different from the method for manufacturing the screen S2 according to the foregoing embodiment in that a concave-flat mold is used instead of the convex-flat mold 13. Therefore, the description of a reflection film transfer process and a base deforming process is omitted.

The convex-flat mold of the foregoing embodiment and the concave-flat mold of this embodiment are equivalent to a flat mold.

Next, a reflection reducing film forming process will be described.

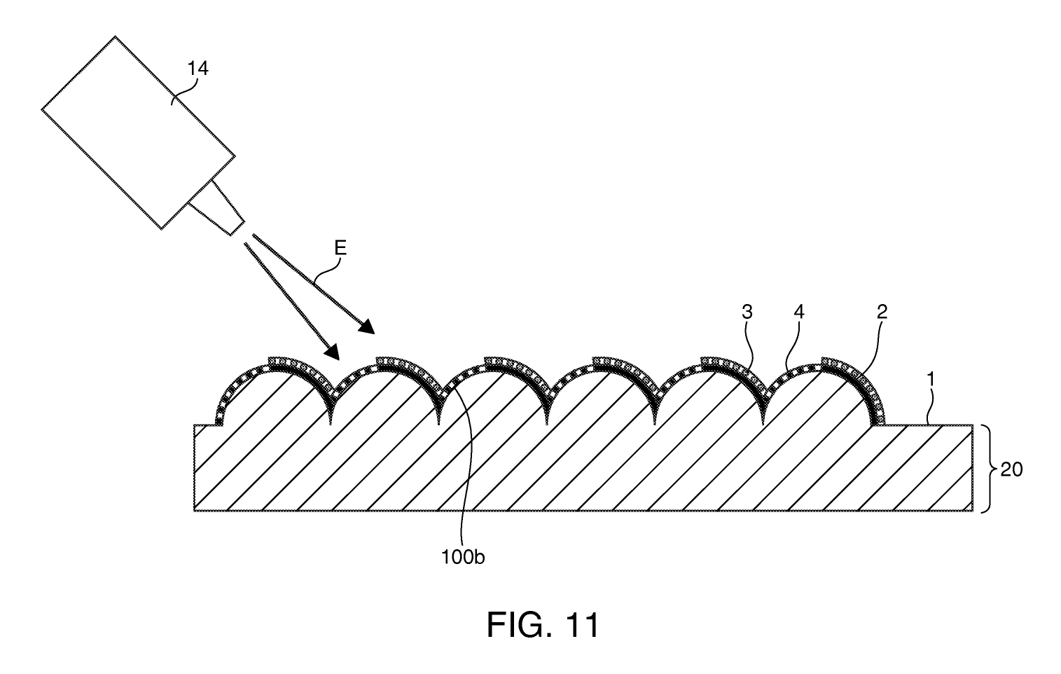

FIG. 11 is a sectional view showing the reflection reducing film forming process of this embodiment.

The screen intermediate body 20 is placed similarly to the screen intermediate body 20 of the above Embodiment 1. In FIG. 11, the screen intermediate body 20 is placed in such a way that the site located at the top in vertical direction when the screen S3 is in the state of use shown in FIG. 3 is the left side in FIG. 11 while the site located at the bottom is the right side in FIG. 11.

A reflection reducing agent accommodated in the spray device 14 is ejected from the left in FIG. 11, passes through a path E and is sprayed and applied onto the screen intermediate body 20. After that, the reflection reducing agent is solidified to form the reflection reducing film 4.

The reflection reducing agent passes through the path E, inclined in relation to the surface where the convex surface shapes 100b are formed, of the screen intermediate body 20, and is sprayed obliquely from the top left side in FIG. 11. Since the convex surface shape 100b is convex, the reflection reducing agent, sprayed through the path E, is obstructed by a convex portion at the center of the convex surface shape 100b and therefore is not applied to a substantially right half portion of the convex surface shape 100b. In other words, a substantially left half portion of the convex surface shape 100b blocks the reflection reducing agent, and the reflection reducing agent is not applied to the substantially right half portion on the surface of the convex surface shape 100b and is applied only to the substantially left half portion on the surface of the convex surface shape 100b, which is shown as the upper part thereof in FIG. 3. In this manner, the screen S3 shown in FIG. 3 is provided.

### Embodiment 6

Next, a screen according to Embodiment 6 and a manufacturing method for the screen will be described. The same description as in the above embodiments will be omitted.

### Structure of Screen

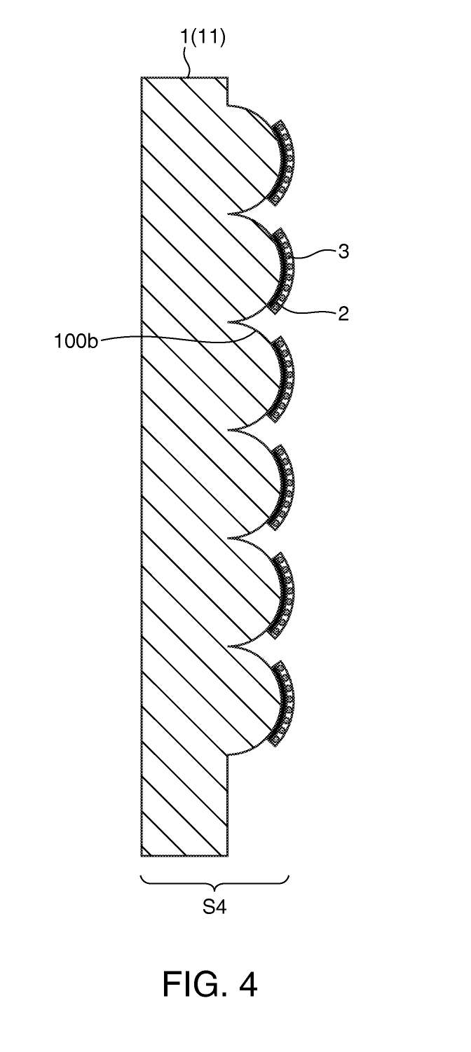

FIG. 4 schematically shows a cross section of a screen S4 according to this embodiment.

As shown in FIG. 4, in the concave-convex screen base 1 of the screen S4, plural convex surface shapes 100b are formed on one side of the screen material 11, as in the screen S3.

Also, the metal reflection film 2 is formed near the center of the surface where each convex surface shape 100b is formed. Moreover, the protection film 3 is formed on the surface of the metal reflection film 2.

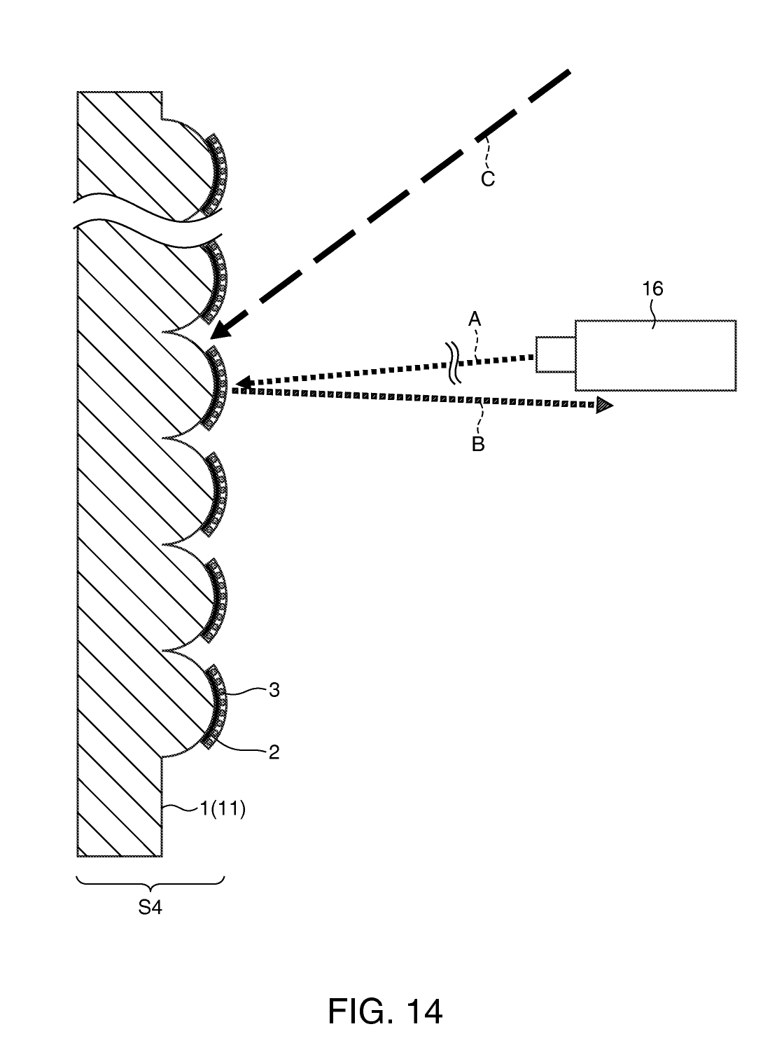

FIG. 14 is a conceptual view showing a path of light when projected light from a projector and external light become incident on the screen S4. In FIG. 14, the projector is placed behind the viewer at the height of the eyes of the viewer. Projected light from the projector 16 passes through path A, is then reflected by the metal reflection film 2 formed near the center of the convex surface shape 100b on the concave-convex screen base 1, then passes through a path B and advances toward the viewer.

Meanwhile, the external light becomes incident on the concave-convex screen base 1 via a path C and becomes incident on pits between the convex surface shapes 100b. Therefore, very little reflected light of the external light advances toward the viewer.

### Method for Manufacturing Screen

A method for manufacturing the screen S4 is similar to the method for manufacturing the screen S3 and is different only in the transfer position of the metal reflection film 2 and the protection film 3. Therefore, the method will not be described further in detail.

As described above, the screens S1 to S4 according to Embodiments 2 to 5 are advantageous in that the base deforming process in which the screen material 11 is shaped and the reflection film transfer process in which the metal reflection film formed in the transfer foils 17, 19 is transferred to the screen material 11 can be carried out simultaneously.

### Embodiment 7

Next, a screen according to Embodiment 7 and a manufacturing method for the screen will be described. The same description as in the above embodiments will be omitted.

### Structure of Screen

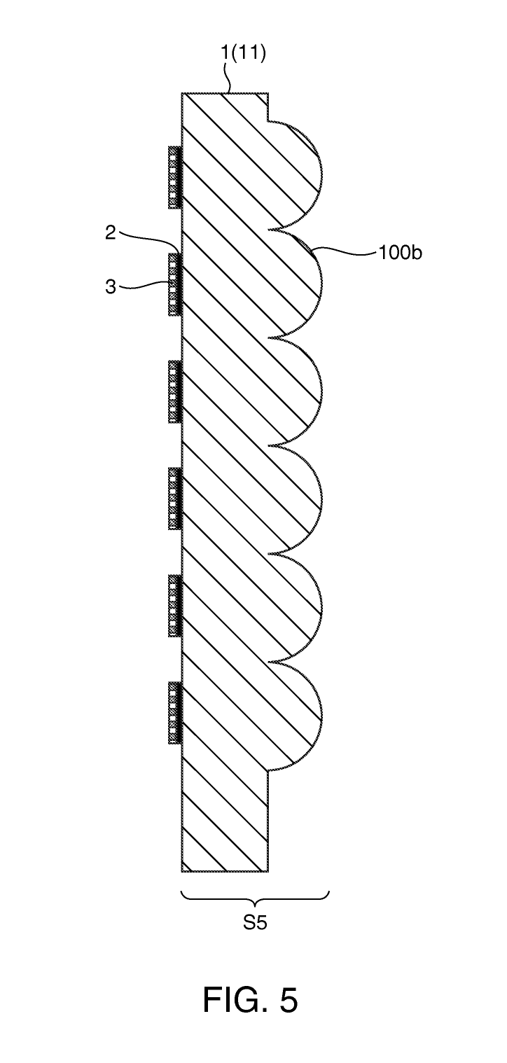

FIG. 5 schematically shows a cross section of a screen S5 according to this embodiment.

As shown in FIG. 5, in the concave-convex screen base 1 of the screen S5, plural convex surface shapes 100b are formed on one side of the screen material 11 made of a light-transmissive resin. The metal reflection film 2 is formed at a position on the back side corresponding to the vicinity of the center of each convex surface shape 100b. Moreover, the protection film 3 is formed on the surface of the metal reflection film 2.

An arrangement pitch of the convex surface shapes 100b formed on the screen material 11 will be described.

As shown in FIG. 18, the convex surface shapes 100b are formed along linear arrangement positions 21 extending horizontally and arrayed vertically in relation to the screen S5 that is set as shown in FIG. 5. In FIG. 18 the arrangement positions 21 of the convex surface shapes 100b are conceptually shown by lines.

A path of light in the case where projected light from a projector and external light become incident on the screen S5 will be described with reference to FIG. 5. The projector is placed behind the viewer at the height of the eyes of the viewer. The projected light from the projector passes through the light-transmissive concave-convex screen base 1, is then reflected by the metal reflection film 2, passes through the concave-convex screen base 1 again and advances toward the viewer.

Meanwhile, of the external light that becomes incident on the surface where the convex surface shapes 100b are formed from obliquely above the screen S5, light that passes through the light-transmissive concave-convex screen base 1 and then passes between the neighboring metal reflection films 2 exits the surface opposite to the surface where the convex surface shapes 100b are formed. Therefore, very little of reflected light thereof advances toward the viewer.

### Method for Manufacturing Screen

A method for manufacturing the screen S5 will be described.

The method for manufacturing the screen S5 is different from the methods for manufacturing the screens S1 to S4 according to the foregoing embodiments in the transfer forming surface of the metal reflection film 2 and the protection film 3. Also, since the screen material 11 made of a light-transmissive resin is used, the reflection reducing film forming process is omitted.

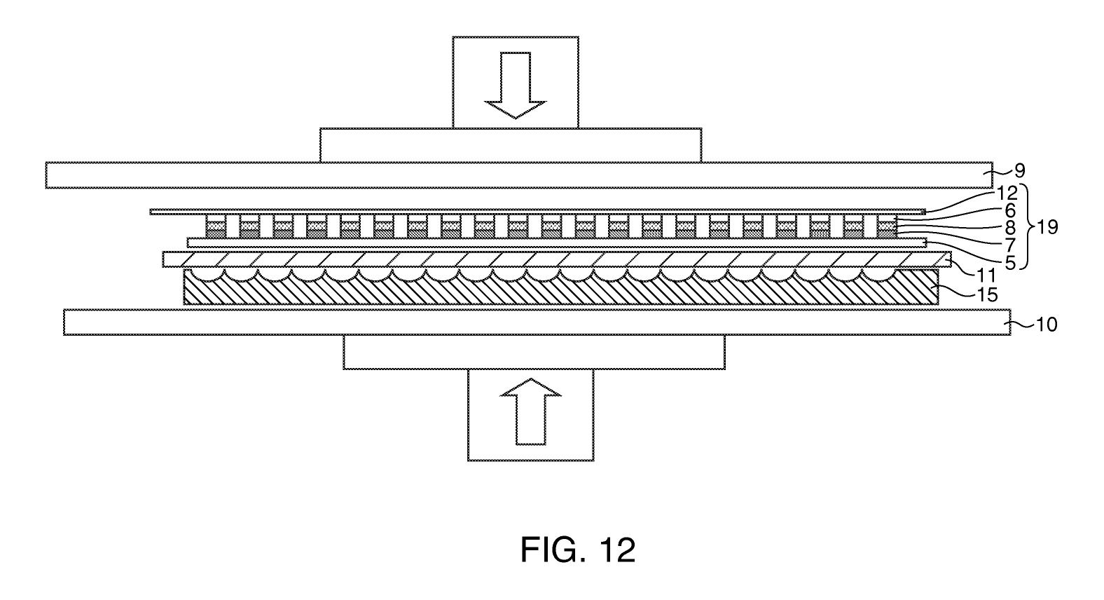

FIG. 12 shows a schematic view of a reflection film forming process and a base deforming process according to this embodiment.

As shown in FIG. 12, a concave-flat mold 15 is set on the bottom pressing plate 10 that is heated in advance, in such a way that one side of the concave-flat mold 15 that is substantially flat faces the bottom pressing plate 10.

Moreover, the transfer foil 19 is set via the screen material 11 in such a way that the hot melt adhesive layer 5 faces the top side of the concave-flat mold 15.

The transfer foil 19 is a multilayer body including the transfer foil base 12, the adhesive layer 6, the protection layer 8, the metal reflection layer 7 and the hot melt adhesive layer 5, as described above. These layers are patterned and interspersed in advance in such a way as to meet the arrangement positions of the concave surface shapes 100a formed on the surface of the screen S5 and a desired position of the metal reflection film 2 within each convex surface shape 100b.

Thermocompression of each member, thus set, is carried out using the heated top pressing plate 9 and bottom pressing plate 10. Then, the transfer foil base 12 is stripped off the protection film 3 transferred to the concave-convex screen base 1. Thus, the screen S5 is formed.

### Embodiment 8

Next, a screen according to Embodiment 8 and a manufacturing method for the screen will be described. The same description as in the above embodiments will be omitted.

### Structure of Screen

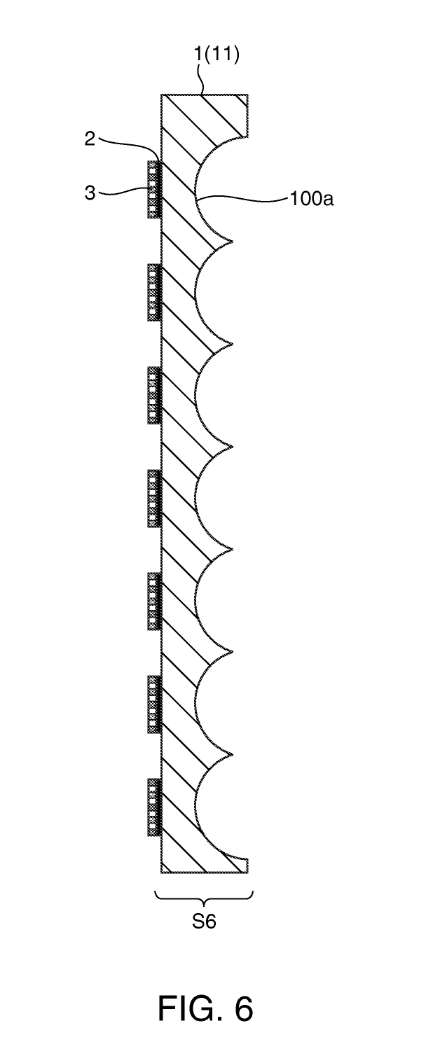

FIG. 6 schematically shows a cross section of a screen S6 according to this embodiment.

In the concave-convex screen base 1 of the screen S6, plural concave surface shapes 100a are formed on one side of the screen material 11 made of a light-transmissive resin. The metal reflection film 2 is formed at a position on the back side corresponding to the vicinity of the center of each concave surface shapes 100a. Moreover, the protection film 3 is formed on the surface of the metal reflection film 2. The planar arrangement of the concave surface shapes 100a in the screen material 11 is similar to the screen S5.

A path of light in the case where projected light from a projector and external light become incident on the screen S6 will be described with reference to FIG. 6. The projector is placed behind the viewer at the height of the eyes of the viewer. The projected light from the projector passes through the light-transmissive concave-convex screen base 1, is then reflected by the metal reflection film 2, passes through the concave-convex screen base 1 again and advances toward the viewer.

Meanwhile, of the external light that becomes incident on the surface where the concave surface shapes 100a are formed from obliquely above the screen S6, light that passes through the light-transmissive concave-convex screen base 1 and then passes between the neighboring metal reflection films 2 exits the surface opposite to the surface where the concave surface shapes 100a are formed. Therefore, very little of reflected light thereof advances toward the viewer.

### Method for Manufacturing Screen

A method for manufacturing the screen S6 is different from the method for manufacturing the screen S5 according to the foregoing embodiment in that a convex-flat mold is used instead of the concave-flat mold 15.

The transfer forming position of the metal reflection layer 7 formed on the back side of the concave-convex screen base 1 of the screens S5 and S6 is situated at the center of each concave surface shape 100a or each convex surface shape 100b of the respective screens S5 and S6. Alignment for this arrangement can be achieved by using the foregoing alignment marks and discrimination marks as the position marks.

According to the embodiments, in the screens S1 to S6, the metal reflection film 2 is formed by transfer, corresponding to the concave surface shapes 100a or the convex surface shapes 100b on the concave-convex screen base 1. Therefore, projected light from the projector 16 can be reflected by the metal reflection film 2 and can be made to advance efficiently toward the viewer.

Also, since the reflection reducing film 4 is formed corresponding to the concave surface shapes 100a or the convex surface shapes 100b, external light can be significantly reduced in reflected light intensity and thus can be prevented from advancing toward the viewer.

Moreover, by using a non-light-transmissive resin for the concave-convex screen base 1, external light can be efficiently absorbed by the screen material 11 and thus can be prevented from entering the eyes of the viewer.

Furthermore, by using a light-transmissive resin for the concave-convex screen base 1, external light can be efficiently transmitted to the back side of the screen and thus can be prevented from entering the eyes of the viewer.

Also, if the metal reflection film 2 is an aluminum thin film, projected light from the projector can be made to advance efficiently toward the eyes of the viewer.

According to the methods for manufacturing the screens S1 to S6, the formation of the concave surface shapes 100a or the convex surface shapes 100b on the concave-convex screen base 1 and the deformation of the metal reflection layer and the protection layer 8 can be made to proceed simultaneously. Moreover, the reflection film transfer process in which the metal reflection film 2 is formed can be carried out simultaneously with the base deforming process in which the concave surface shapes 100a or the convex surface shapes 100b are formed. Thus, a highly efficient manufacturing method that cannot be achieved by a traditional technique using known vacuum evaporation of a metal as a process for forming a metal reflection film on concave surface shapes or convex surface shapes can be provided.

Moreover, by providing discrimination marks on the convex-flat mold 13 and alignment marks on the transfer foil 19, the positions of the metal reflection film 2 and the center positions on the surface where the concave surface shapes 100a or the convex surface shapes 100b are formed can be easily aligned with each other when transferring the metal reflection film 2.

Furthermore, the arrangement of the concave surface shapes 100a or the convex surface shapes 100b, and the arrangement of the metal reflection film 2 and the like in relation to the concave surface shapes 100a or the convex surface shapes 100b can be carried out more easily at desired positions, and a less expensive screen can be provided.

The entire disclosure of Japanese Patent Application No. 2011-248289, filed Nov. 14, 2011 is expressly incorporated by reference herein.

What is claimed is:

1. A screen which reflects projected light and performs display in a display area, comprising
a screen base,
wherein the screen base has a concave surface shape or a convex surface shape formed on one side of a screen material, and
a metal reflection film that is formed by transfer from a metal reflection layer formed on a transfer foil is provided on one side of the screen base corresponding to the concave surface shape or the convex surface shape within the display area.

2. The screen according to claim 1,
wherein a reflection reducing film is formed at a site where the metal reflection film is not formed by transfer, corresponding to the concave surface shape or the convex surface shape.

3. The screen according to claim 1,
wherein a reflection reducing film is formed in a portion on the metal reflection film, corresponding to the concave surface shape or the convex surface shape.

4. The screen according to claim 1,
wherein the metal reflection film is formed by transfer substantially at a center of the convex surface shape within the display area.

5. The screen according to claim 1,
wherein the screen base is made of a non-light-transmissive base.

6. The screen according to claim 1,
wherein the screen base is a light-transmissive base and the metal reflection film is formed by transfer at a position on aback side corresponding to a center of the concave surface shape or the convex surface shape within the display area.

7. The screen according to claim 1,
wherein a protection film which protects the metal reflection film is formed by transfer simultaneously with the metal reflection film.

8. The screen according to claim 1,
wherein the metal reflection film is an aluminum thin film.

9. The screen according to claim 1,
wherein the screen material is made of a hard vinyl chloride resin.

10. The screen according to claim 2,
wherein the reflection reducing film is made of a solid form of black resin paint.

11. A method for manufacturing a screen which reflects projected light and performs display, the method comprising:
reflection film transfer in which at least a metal reflection film is formed by transfer using a transfer foil on one side of a screen material; and
base deformation in which a concave surface shape or a convex surface shape is molded with a flat mold on one side of the screen material, thus forming a screen base.

12. The method for manufacturing the screen according to claim 11,
wherein the reflection film transfer and the base deformation are carried out simultaneously.

13. The method for manufacturing the screen according to claim 11, further comprising
reflection reducing film formation in which a reflection reducing film is formed on one side of the screen base.

14. The method for manufacturing the screen according to claim 13,
wherein the reflection film transfer, the base deformation and the reflection reducing film formation are carried out simultaneously.

15. The method for manufacturing the screen according to claim 11, comprising
alignment in which the flat mold and the transfer foil are aligned in position so that position marks formed at positions corresponding to at least two or more corners on a surface of the flat mold used in the base deformation and position marks formed at positions corresponding to at least two or more corners on the transfer foil as a base for transferring the metal reflection film meet each other.

16. The method for manufacturing the screen according to claim 11,
wherein the base deformation and the reflection film transfer include heat pressing.

17. The method for manufacturing the screen according to claim 13, comprising
spraying a reflection reducing agent.
